(19) United States
(12) Patent Application Publication
(10) Pub. No.: US 2026/0284945 A1
(43) Pub. Date: Sep. 24, 2026

(54) A METHOD FOR FORMING A STRUCTUAL ELEMENT FOR A VEHICLE

(71) Applicant: Silverstone Performance Technologies Limited, Towcester Northamptonshire (GB)

(72) Inventors: Claudio SANTONI, Silverstone, Towcester Northamptonshire (GB); Alessandro SORDON, Silverstone, Towcester Northamptonshire (GB)

(21) Appl. No.: 19/477,690

(22) PCT Filed: Apr. 26, 2024
(86) PCT No.: PCT/EP2024/061526

§ 371 Date: Oct. 22, 2025

(30) Foreign Application Priority Data
Apr. 27, 2023 (GB) 2306213.6

(51) Int. Cl. B29C 45/14; B29C 65/54; B29K 305/00; B29L 31/30

(52) U.S. Cl. CPC B29C 45/14467; B29C 65/542; B29K 2305/00; B29L 2031/3005

(57) ABSTRACT

Disclosed herein is a method for forming a reinforced structural element for a vehicle, the method comprising: providing (102) a thin-walled hollow member; supporting (104) at least one portion of the thin-walled hollow member; and overmoulding (106) a structural element material to the at least one portion of the thin-walled hollow member to form the reinforced structural element.

### FIELD OF THE INVENTION

The present invention relates to a method for forming a structural element for a vehicle. More specifically, the present invention relates to a method for forming a structural element for a vehicle such as the structural enclosure for a high voltage battery.

### BACKGROUND

Electric vehicles (EVs) carry heavy batteries which must be protected in the event of a crash or collision, which can cause pack intrusion or damage of a battery.

Known techniques to reduce the forces from frontal or rear collisions have been to create crumple zones in the vehicle to absorb the impact forces and transfer the crash loads across the front or rear of a vehicle. However, EV batteries or battery packs are particularly vulnerable from side impact collisions, since there is limited lateral space in a vehicle to include a suitably sized crumple zone for side collisions.

Battery box assemblies typically include moulded plastic panels which are assembled together to hold a battery. Plastic materials and moulding processes, such as compression or injection moulding, allow different shapes to be formed and also do not add significant weight to an overall battery pack assembly/electric vehicle. However, current moulding methods are limited and produce battery box panels that do not provide weight efficient protection from crash loads.

Reinforcing a battery pack or battery box panels with stronger materials or additional layers may provide a solution but may significantly increase the weight or the overall size of the battery box/pack which in turn may reduce the overall efficiency of an electric vehicle.

An object of the invention is to address these issues and to provide efficient reinforcements for structural elements for a vehicle assembly.

### SUMMARY OF INVENTION

According to an aspect of the invention, there is provided a method for forming a reinforced structural element for a vehicle, the method comprising: providing a thin-walled hollow member; supporting at least one portion of the thin-walled hollow member; and overmoulding a structural element material to the at least one portion of the thin-walled hollow member to form the reinforced structural element.

In this way, a structural element can be effectively reinforced with lightweight components whilst allowing the structural element to be further overmoulded into a desired shape. One or more thin-walled hollow members may be provided in the reinforced structural element. A plurality of thin-walled hollow members may be supported at a same time or may be supported sequentially along different portions of the structural element to reinforce an overmoulded structural element. A reinforced and overmoulded structural element is thus able to provide improved mechanical properties for safety requirements in the vehicle industry, for example Economic Commission for Europe (ECE) regulations for side crash impact and push tests (e.g. a 100 kN load). In particular, the present reinforced structural elements can be effectively used in battery box structures and battery covers to protect high voltage batteries in electric vehicles.

Thin-walled hollow members include metallic or non-metallic tubes, such as aluminium extrusions or steel tubes, or carbon fibre reinforced (CFRP) pultrusions, typically exhibit exceptional mechanical properties (including high tensile or compressive strength and stiffness and high strength-to-weight ratio) and can reinforce a structural element in a highly efficient way. Thin-walled hollow members such as CFRP pultrusions do not significantly increase the volume or mass of an overall structure yet can allow external forces on a structural element to be effectively transferred into the thin-walled hollow member. This is particularly important for EVs where the battery packs introduce a significant weight to the vehicle and it is desirable to control the overall weight of the battery pack and electric vehicle within a target range.

As will be appreciated, elongated thin-walled hollow members such as metallic extrusions or tubes or fibre reinforced pultrusions exhibit improved mechanical properties along a principal longitudinal axis of the elongated member (i.e. against axial forces applied along a wall of a tubular member) but are more susceptible to deformation, fracture, buckling or collapse to applied off-axis forces, especially forces substantially orthogonal to the longitudinal axis.

In addition, the thin-walled hollow members may advantageously be incorporated with the structural elements in a way to provide a multi-material configuration where each layer or portion of overmoulded material can perform a specific function such that interior surfaces can be used for running cables, wirings or fluids through the structural element/overall assembly.

It has previously not been considered to include thin-walled hollow members in moulding processes since overmoulding techniques such as compression moulding, injection moulding, vacuum infusion, resin transfer moulding or liquid infusion typically require significant in-mould pressure to be applied onto a structural element which may crush a thin-walled hollow member that is attached or integrated to the structural element during the overmoulding process. For example, injection moulding in-mould pressure can easily exceed 150MPa. This pressure, if applied in an overmoulding configuration to a CFRP pultrusion with fibres substantially orientated along the principal longitudinal axis and material wall thickness of less than 1 mm and outer size greater than 20 mm can easily result in a collapse of the pultrusion member and overmoulding process failure. However, the present invention allows thin-walled hollow members to be effectively incorporated into moulding processes to provide a reinforced structural element.

Preferably, supporting the at least one portion of the thin-walled hollow member comprises inserting a solid support or injecting a fluid into the thin-walled hollow member. In this way, the solid support or fluid can provide a mechanical support to the thin-walled hollow member to counteract any external pressures on the thin-walled hollow member during the overmoulding process. The at least one portion of the thin-walled hollow member that is supported experiences the overmoulding pressures in the overmoulding step.

The solid support may be in the form of a mandrel or rod which fills the hollow space in the at least one portion of the thin-walled hollow member. Importantly the solid support is sufficiently contacts the internal surface of the thin-walled hollow member to ensure that the external pressure (from the overmoulding process) is able to transfer through the wall of the thin-walled hollow member into the solid support. As will be understood, the solid support must be sufficiently robust to withstand and “absorb” the external pressure/forces.

The supporting fluid may be a gas or a liquid, or even a foam or expanding foam, that is injected into the hollow space in the at least one portion of the thin-walled hollow member. In this way, the wall of the thin-walled hollow member can be pneumatically, hydrostatically or physically supported from within during the overmoulding process to prevent the wall of the hollow member from buckling or collapsing. The fluid fills the space in the hollow member and may be injected into the hollow member to provide a variable hydrostatic pressure to actively counteract any external pressure from the overmoulding process. During the overmoulding process, the fluid pressure is controlled to prevent the thin-walled hollow member from failing, e.g. deforming, distortion, rupturing or bursting from within, by controlling the pressure differential between the inside and the outside of the thin wall of the hollow member. A similar technique is used in gas-assisted injection moulding for producing polymeric hollow components.

Preferably, the fluid is a high-pressure gas. In this way, the support can be easily removed from within the thin-walled hollow member once the overmoulding process has been completed and the structural element has been formed.

Use of a solid support allows the solid support to be readily removed from the structural element after the overmoulding step, which leaves the structural element reinforced by the thin-walled hollow member. Similarly the injection of fluid may be ceased after the overmoulding step to provide the reinforced structural element. As will be appreciated, the fluid in the thin-walled hollow member may be drained out of the hollow member.

Supporting the at least one portion of the thin-walled hollow member may comprise arranging the at least one portion of the thin-walled hollow member in a connector piece. The thin-walled hollow member may be positioned or arranged in a connector piece in a way that allows external pressure in the overmoulding process to be exerted onto the connector piece rather than thin-walled hollow member. In this way, the connector piece prevents any distortion, deformation or collapse of the thin-walled hollow member.

The connector piece may comprise a material that is different from the material of the thin-walled hollow member and/or the material of the structural element. The material of the connector piece may be selected to help overcome/avoid any chemical incompatibility between the thin-walled hollow member and/or the material of the structural element, which in turn may improve the joining process, insulation, and/or resistance to corrosion of the reinforced structural element.

The connector piece may comprise a material with a Young's modulus that is substantially lower than that of the thin-walled hollow member. In this way, the residual stress induced from the manufacturing process (including the overmoulding process) or any stress arising from difference in the respective coefficients of thermal expansion (CTE) between the structural element and the thin-walled hollow member may be reduced when the assembly is subject to temperature variations. The method may further comprise joining the thin-walled hollow member to the connector piece, preferably by bonding, fastening or welding.

Alternatively the at least one portion of the thin-walled hollow member may be arranged in the connector piece by overmoulding a connector piece material to the at least one portion of the thin-walled hollow member. In this way, the method effectively utilises multiple overmoulding steps to form the reinforced structural element. As will be appreciated the method may include at least two distinct and sequential overmoulding steps, where a first overmoulding step the connector piece is overmoulded to the thin-walled hollow member, and in a second step the structural element material is overmoulded to the combined connector piece-thin-walled hollow member to form the reinforced structural element (for example a finished reinforced battery casing).

The connector piece may provide geometrical features or datums that provide location of the thin-walled element or the locator piece itself when inside the overmoulding mould tool. The connector piece may further provide such geometrical features or datums to locate an array of multiple thin-walled elements conveniently configured to deliver their structural performance and functionalities as described before.

The connector piece may cover an opening of the thin-walled hollow member. In this way, the connector piece may act as an end piece for one of the ends of the thin-walled hollow member. As such, the thin-walled hollow member may be arranged in the connector piece in different configurations or angles, which in turn enables different joining configurations of the connector piece with the structural element. For example, the reinforced structural element may be in the shape of a panel with an upturned projection (e.g. an upturned flange) and the connector piece may be suitably shaped to adjoin or connect to the upturned projection to provide a corner arrangement of the structural element for an overall structural assembly. Advantageously, the connector piece may be arranged at a corner or an edge of a structural assembly, which in turn allows the thin-walled hollow member to provide effective reinforcement in different directions.

The thin-walled hollow member may comprise an elongated shape having a principal axis. Elongated thin-walled hollow members such as metallic extrusions or pipes or fibre reinforced pultrusions have a principal longitudinal axis along which provide effective reinforcement in a direction parallel to the principal axis. As will be appreciated, a structural assembly may be designed such that the energy/force exerted against a structural element of the assembly can be transferred into the elongated thin-walled hollow member along its principal axis. Thin-walled hollow members of other shapes and cross sections may also be used, such as rectangular shaped or round members or multicavity sections or sections with protruding flanges.

The principal axis of the thin-walled hollow member may be parallel to a plane of the reinforced structural element. The principal axis of the thin-walled hollow member may be at an angle to a plane of the reinforced structural element. In this way, one or more thin-walled hollow members may be arranged in different configurations as the structural element material is overmoulded to the thin-walled hollow member to provide effective reinforcement to the final reinforced structural element/structural element assembly. Arranging thin-walled hollow members in this way also offers space-efficient reinforcements for a structural element which may be particularly advantageous for battery box designs where the “empty space” surrounding a battery is typically limited and highly restrictive. For example, the gap between the outer surface of a battery and the inner surface of a structural element (i.e. a battery box panel/cover) may be around 20 millimetres.

The thin-walled hollow member may comprise a retractable core. The thin-walled hollow member with a retractable core may be extended or retracted during the manufacturing process. For example, in order to overmould a connector piece or a structural element to the thin-walled hollow member, the core may extended to support the hollow member. The retractable core of the thin-walled hollow member may then be retracted after the connector piece or structural element is overmoulded for a further connection (by bonding, welding or fastening for example) to another connector piece or structural element or connector piece in the overall assembly. The retractable core of the thin-walled hollow member may then be left in its extended configuration after the connector piece or structural element is overmoulded for a further connection (by bonding, welding or fastening for example) to another connector piece or structural element or connector piece in the overall assembly. The rectractabe core may then be retracted. The retractable core may be metallic or non-metallic. A metallic core could be solid or hollow or it may contain fluid passages to facilitate thermal regulation of the core and, in turn, the overmoulding process. The metallic core could be made of a single piece or multiple pieces to facilitate the retraction process. The core could be made of bound aggregates, like sand cores commonly used in metal foundries.

The core could be made of ceramic compound. The aggregates or ceramic cores could be retracted by simple extraction through an opening or by mechanical fragmentation or by dissolution through a solvent, for example water. The core could be made of a material that conveniently expand at temperature, therefore it could be extended into the thin walled member at the lower temperature and expand afterwards, thus providing intimate mechanical support to the inside of the thin-walled member. The core could comprise an inflatable structure that extends when inflated thus providing intimate mechanical support to the inside of the thin-walled membrane.

Preferably, supporting the thin-walled hollow member comprises providing the retractable core is in a retracted position for the overmoulding step.

The thin-walled hollow member may comprise a fibre reinforced plastic pultrusion. The thin-walled hollow member may comprise a metallic extrusion or tube. The thin-walled hollow member may have a variable cross-section along its main axis. This could be achieved through a multitude of manufacturing processes, for example hydroforming or autoclave moulding or 3D printing or injection moulding or other existing processes that can produce thin-walled structural elements made of metallics or non-metallics materials including fibrous materials and other composite materials.

Preferably, overmoulding the structural element material to the at least one portion of the thin-walled hollow member comprises one or more of: compression moulding, injection moulding, vacuum infusion, resin transfer moulding and/or liquid infusion. Injection moulding may comprise injection moulding fibre-reinforced or unreinforced resins. Compression moulding may comprise fibre-reinforced compounds.

Preferably, the structural element material comprises a fibrous reinforcement. For example, the structural element material may include fibres having a predetermined length and/or a range of different lengths to provide reinforcement to the structural element from forces or pressures in different directions. The length or range of lengths of the fibres may be selected based on a dimension of the final reinforced structural member (e.g. the design thickness of the reinforced structural member). The length of a fibre length may be being greater than 0.1 mm or 1 mm or preferably greater than 25 mm, and a structural element material formulation may include fibres of different lengths used in combination.

The use of a fibre-reinforced structural element material, or a structural element material comprising a fibrous reinforcement, may be implemented with thermosetting resins such as epoxy or polyester or vinylester, or thermoplastic resins such as nylon or polypropylene or others. A combination of different resins may be used in the present method. For example, thermosetting resins for the thin-walled hollow member may be combined with thermoplastic resins for the overmoulded materials (i.e. the connector piece or the structural element).

According to another aspect of the invention there is provided a reinforced structural element for a vehicle formed using the disclosed method.

### BRIEF DESCRIPTION OF DRAWINGS

Embodiments of the invention are now described, by way of example, by reference to the drawings, in which:

FIG. 1 is a flow diagram of a method for forming a structural element for a vehicle in an embodiment of the invention;

FIG. 2 is a perspective view of a structural element for a vehicle in an embodiment of the invention;

FIG. 3A is a perspective view of a structural element for a vehicle in an embodiment of the invention;

FIG. 3B is a perspective view of a structural element for a vehicle in an embodiment of the invention; and

FIG. 4 is a schematic view of a battery box comprising reinforced structural elements for a vehicle in an embodiment of the invention.

### DETAILED DESCRIPTION

The methods provided herein improve the mechanical properties of structural elements for moulded and overmoulded assemblies for vehicles by reinforcing the structural elements with lightweight hollow members, such as elongated carbon fibre reinforced plastic pultrusions. By supporting the thin-walled hollow members during the overmoulding process allows the hollow members to be effectively integrated into the final shape of the structural element, as determined by design or manufacturing requirements.

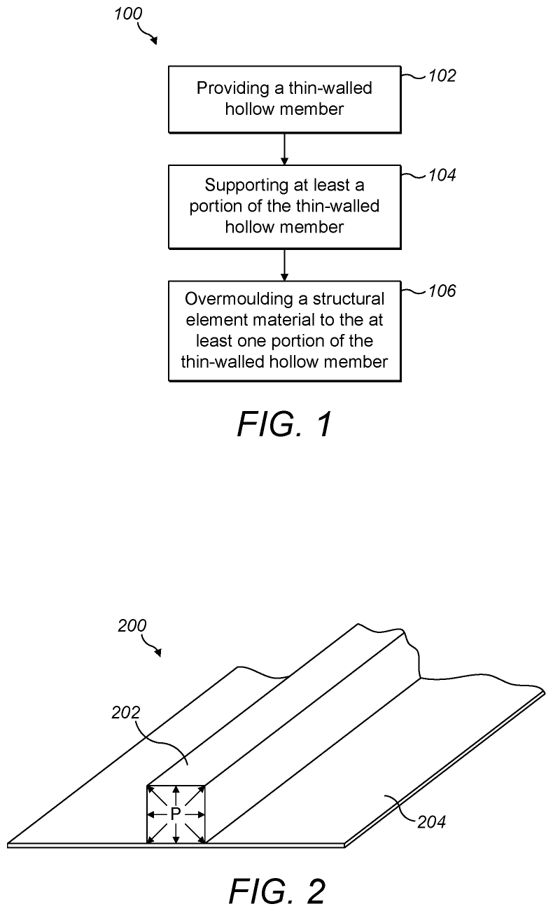

FIG. 1 sets out a method 100 for forming a reinforced structural element according to the present invention.

At step 102 a thin-walled hollow member, such as a metallic extrusion or a fibre reinforced plastic pultrusion, is provided. As will be understood, a plurality of thin-walled hollow members may be provided.

At step 104 the thin-walled hollow member is supported at one or more portions of the hollow member. For example, a tube or rod-shaped hollow member may be supported along a section of its length. Supporting the thin-walled hollow member portion includes one or more of: inserting a solid support (such as a rod or mandril), injecting a fluid, and/or arranging the portion in a connector piece. As will be understood by the skilled person, the insertion of a solid support and the injection of a fluid provide a support to the internal surface of the wall of the hollow member, and the arrangement of the portion in a connector piece provides a external support to hollow member to shield the hollow member from any excessive overmoulding pressure/forces. Accordingly, the at least one portion of the thin-walled hollow member may be supported from either surface (internal or external) of the wall of the hollow member or from both surfaces.

At step 106 a structural element material is overmoulded to the supported at least one portion of the thin-walled hollow member. Overmoulding may include compression moulding where the structural element material with the at least one portion of the thin-walled hollow member are placed in a mould/mould tool and a mould cavity pressure is applied to the two components such that the structural element material is overmoulded into shape around the hollow member portion. Alternatively the overmoulding process may include injection moulding where the hollow member portion is placed in a mould and the structural element material is injected into the mould to the mould cavity pressure to form the structural element. Other overmoulding processes may also be used as will be appreciated by the skilled person, such as vacuum infusion, resin transfer moulding, and/or liquid infusion.

Overmoulding step 106 can include multiple overmoulding cycles, using different overmoulding techniques, to form a multi-layer and/or multi-material configuration. Each layer in the structural element may perform a different function or provide a different feature/property to the overall structural assembly. Importantly, in each overmoulding process, the at least one portion of the thin-walled hollow member is supported internally and/or externally to counteract any overmoulding pressure (e.g. excessive mould cavity pressure) from damaging the thin-walled hollow member.

FIG. 2 shows an arrangement 200 of a thin-walled hollow member 202 and a structural element material 204.

The thin-walled hollow member 202 has a fluid, i.e. a gas or liquid, injected into its hollow centre to provide a hydrostatic pressure against the internal surface of the wall of the hollow member. The pressure of the injected fluid can be adjusted to counteract and compensate against the mould cavity pressure during the overmoulding process. In this specific example, the thin-walled hollow member 202 is in the shape of a rod with a square cross-section. However, different shapes and different cross-sections will be apparent to the skilled person. The support of thin-walled hollow member from its internal surface may also be achieved by use of a solid rod or mandril that is inserted into the hollow centre.

The structural element material 204 is overmoulded to the thin-walled hollow member during the overmoulding process into the form of a panel.

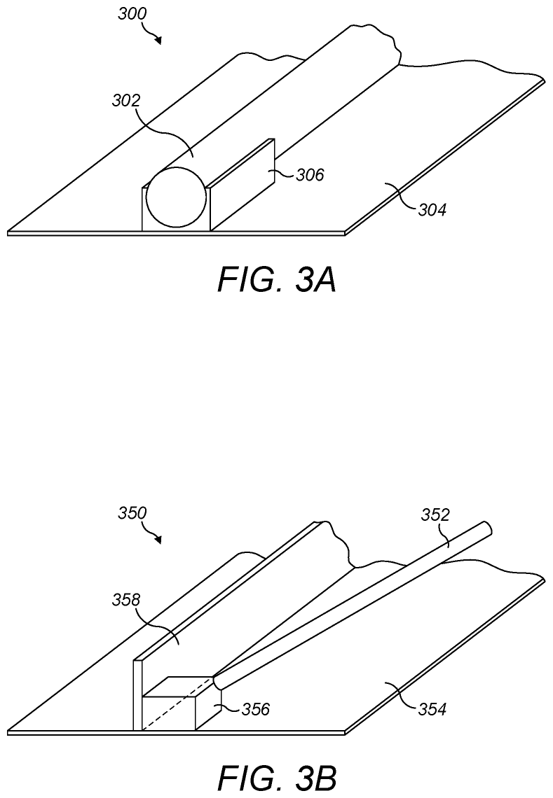

FIG. 3A shows another arrangement 300 of a thin-walled hollow member 302 and a structural element material 304.

The thin-walled hollow member 302 is placed in a connector piece 306. Optionally the thin-walled hollow member 302 may be joined to the connector piece 306 by adhesive bonding, welding, fastening, overmoulding or a combination of the above. Alternatively the thin-walled hollow member 302 may be held in place in the connector piece 306 by a push-fit mechanism by design. As will be appreciated, if the connector piece 306 is overmoulded to the thin-walled hollow member 302, the thin-walled hollow member 302 will be suitably supported to prevent the thin-walled hollow member 302 from distortion or collapse. For example, a solid or fluid support may be provided in the manner described above, or the thin-walled hollow member 302 may include a retractable core that is maintained in its retracted position to support the thin wall of the hollow member 302 during the overmoulding process.

Similar to the specific example in FIG. 2, the structural element material 304 is overmoulded into shape and to the thin-walled hollow member during the overmoulding process.

The connector piece 306 connects the thin-walled hollow member 302 to the structural element panel 304 and acts as a shield to prevent the mould cavity pressure of the overmoulding process from damaging the thin-walled hollow member 302.

When the structural element material 304 is overmoulded to the connector piece 306, pre-assembly of connector piece 306 to thin-walled hollow member 302 can take away any “undercut” regions of the thin-walled hollow member 302 that would otherwise not be compatible with the main tooling (drafting) direction for the overmoulding of the structural element material 304. Undercut regions in the thin-walled hollow member 302 can allow for optimal cross section design, independent of drafting requirements for the overmoulding process.

FIG. 3B shows another arrangement 350 of a thin-walled hollow member 352 in a connector piece 356 and a structural element material 354.

In this arrangement 350, the structural element material 354 overmoulded into the shape of a panel with a projection 358 extending perpendicularly from a major surface of the panel to provide a corner between the panel and the projection 358.

The connector piece 356 is arranged at the corner and the thin-walled hollow member 352 is received in the connector piece 356 such that the received open end of the hollow member 352 is covered by the connector piece 356. As will be appreciated, this allows the thin-walled hollow member 352 to be position at a different angles relative to the structural panel 354, i.e. where the main longitudinal axis of the hollow member 352 is at an angle to the plane of the panel 354.

This “off-axis” hollow member arrangement allows a thin-walled hollow member to be joined to a structural panel or element in a multitude of different ways, thus increasing the versatility and flexibility of reinforced structural element assemblies.

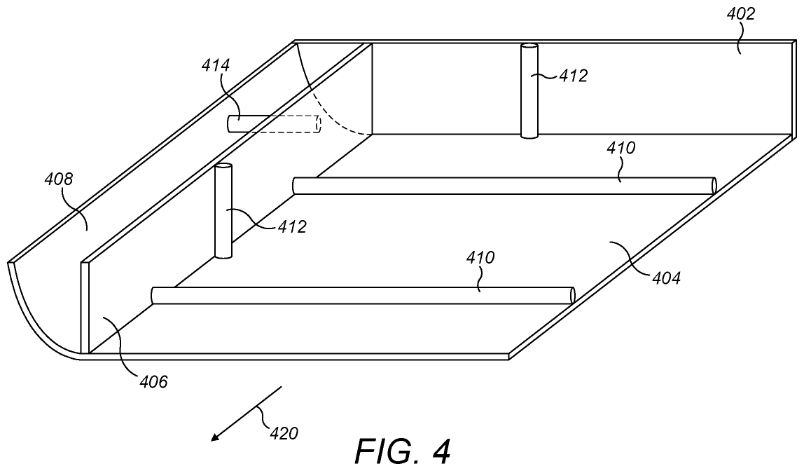

FIG. 4 is a schematic view of a section of a battery box 400 with a plurality of thin-walled hollow members. For ease of understanding, FIG. 4 only shows a back panel 402, a base panel 404, a side panel 406 and a curved panel 408 in the battery box 400 section.

The base panel 404 is reinforced by thin-walled hollow members 410 which are spaced across the base panel 404 to provide reinforcement. The thin-walled hollow members 410 are arranged parallel to the plane of the base panel 404. Since the hollow members 410 can efficiently withstand axial loads, the hollow members 410 may be arranged horizontally and orthogonal to a driving direction 420 of a vehicle in order to provide reinforcement to the battery box 400 from side impact forces.

Back panel 402 and side panel 406 and reinforced by thin-walled hollow members 412 to provide reinforcement to the battery box 400 in a vertical direction (i.e. normal to the base panel 404), which may protect a housed battery (not shown) from crushing forces due to a vehicle impacting uneven surfaces or speed bumps on a driving surface.

Curved panel 408 extends in an upward direction from the base panel 404 and outwardly from the side panel 406 (i.e. away from a battery (not shown) housed in the battery box 400). The curved panel 408 is reinforced against side impact forces by thin-walled hollow member 414, which extends between the side panel 406 and the curved panel 408.

As will be appreciated by the skilled person, a battery box or another structural element assembly will have a variety of different shapes and sizes and the present disclosure enables the structural elements, such as panels or covers, to be effectively reinforced against pressures or forces from different directions. The present invention allows thin-walled hollow members to be arranged parallel to a major plane or a principal axis of the structural element or at an angle/off-axis to the major plane to provide effective reinforcement to a structural element.

1. A method for forming a reinforced structural element for a vehicle, the method comprising:
providing a thin-walled hollow member;
supporting at least one portion of the thin-walled hollow member; and
overmoulding a structural element material to the at least one portion of the thin-walled hollow member to form the reinforced structural element.

2. The method of claim 1, wherein supporting the at least one portion of the thin-walled hollow member comprises inserting a solid support or injecting a fluid into the thin-walled hollow member.

3. The method of claim 1, wherein supporting the at least one portion of the thin-walled hollow member comprises arranging the at least one portion of the thin-walled hollow member in a connector piece.

4. The method of claim 3 further comprising joining the thin-walled hollow member to the connector piece, preferably by bonding, fastening or welding.

5. The method of claim 3, wherein the at least one portion of the thin-walled hollow member is arranged in the connector piece by overmoulding a connector piece material to the at least one portion of the thin-walled hollow member.

6. The method of claim 3, wherein the connector piece covers an opening of the thin-walled hollow member.

7. The method of claim 1, wherein the thin-walled hollow member comprises an elongated shape having a principal axis.

8. The method of claim 7, wherein the principal axis of the thin-walled hollow member is parallel to a plane of the reinforced structural element.

9. The method of claim 7, wherein the principal axis of the thin-walled hollow member is at an angle to a plane of the reinforced structural element.

10. The method of claim 1, wherein the thin-walled hollow member comprises a retractable core.

11. The method of claim 10, wherein supporting the thin-walled hollow member comprises providing the retractable core is in a retracted position for the overmoulding step.

12. The method of claim 1, wherein the thin-walled hollow member comprises a fibre reinforced plastic pultrusion.

13. The method of claim 1, wherein the thin-walled hollow member comprises a metallic extrusion.

14. The method of claim 1, wherein overmoulding the structural element material to the at least one portion of the thin-walled hollow member comprises one or more of: compression moulding, injection moulding, vacuum infusion, resin transfer moulding and/or liquid infusion.

15. The method of claim 1, wherein the structural element material comprises a fibrous reinforcement.
